(19) United States
(12) Patent Application Publication
(10) Pub. No.: US 2023/0177674 A1
(43) Pub. Date: Jun. 8, 2023

(54) VEHICLE PROTECTION FENCE REPAIR PLATING SYSTEM AND METHOD USING ARTIFICIAL INTELLIGENCE

(71) Applicant: KEMP CO., LTD., Ulsan (KR)

(72) Inventors: Hyunjun CHON, Ulsan (KR); Aram HAN, Ulsan (KR); Yeongdeok KO, Suwon-si (KR); Do Hyeong KIM, Ulsan (KR)

(73) Assignee: KEMP CO., LTD., Ulsan (KR)

(21) Appl. No.: 17/541,192

(22) Filed: Dec. 2, 2021

(51) Int. Cl. G06T 7/00; B60R 11/04

(52) U.S. Cl. CPC G06T 7/0008; B60R 11/04; G06T 2207/30156; G06T 2207/30248; G06T 2207/20084

(57) ABSTRACT

Disclosed is a vehicle protection fence repair plating system and method using artificial intelligence. The system includes a data management module that collects video data about a vehicle protection fence and pre-processes images per frame, a data prediction module that receives the data of the pre-processed image and performs machine learning for a corrosion level of the vehicle protection fence according to a preset labeling standard to detect a work area, and a process management module that standardizes customized work instructions according to a determination result of an image state of the vehicle protection fence, which has been machine-learned, wherein the data prediction module specifies a repair range of the vehicle protection fence and a work method for each repair range according to the labeling standard.

### BACKGROUND

The inventive concept relates to a vehicle protection fence repair plating system and method, and in particular, a vehicle protection fence repair plating system and method using artificial intelligence capable of recognizing a repair plating process target through vision artificial intelligence, automatically determining a repair plating work area through a stepwise classification system and obtaining an optimal work method for each area.

In general, a vehicle protection fence, which is one of vehicle protection and safety facilities, is provided by the Korea Expressway Corporation according to ‘Rules on maintenance and repair of roads’ (Article 2) and ‘Rules on structure and facility standards of roads’ (Article 38), ‘Road Safety Facility Installation and Management Guidelines’ and the like.

However, according to the latest government audit data, 48% of vehicle protection fences do not meet the installation standards in highways across the country, leading to a serious situation in which half of vehicle protection fences do not meet the standards.

Accordingly, since 1997, the standards for vehicle protection fences have been revised three times in the road safety facility installation and management guidelines, but it is revealed that it will take 39 years to completely improve vehicle protection fences on highways.

In addition, based on the data submitted by the Korea Expressway Corporation, an official belonging to the Land Infrastructure and Transport Committee said, “The ultimate countermeasure against unsuitable vehicle protection fences is to completely improve vehicle protection fences, but as it takes a considerable amount of time for improvement, separate measures are needed to prevent immediate accidents, and measures to shorten a construction period of vehicle protection fences must be prepared.”

However, the existing vehicle protection fence repair work was proposed and proceeded by public institutions, but proposals were frequently rejected because on-site data on corrosion and defective conditions were not quantified.

In addition, there was an inefficiency of specifying a road of a certain distance and performing repair work for the vehicle protection fence for the distance when the vehicle protection fence repair work is in progress.

Usually, a work vehicle drives along the vehicle protection fence at a slow speed, but due to such inefficient work progress, road control and safety personnel are required in the middle of the road, thus causing a problem in that the cost is not small.

In addition, when a company performing vehicle protection fence repair work receives an order from a customer, an information system for vehicle protection fence management has not been established so far, so that workers with a lot of work experience in repair work perform visual inspection, determine a portion necessary for repair, and verbally instruct a repair method, with their know-how.

Alternatively, when receiving an order for work, the worker performs visual inspection, then writes a work order for the main work (rust removal and plating), so that the repair process is carried out based on the work order.

Accordingly, it is easy to overlook the difference in the corroded portions, and there is a problem in that coating marks are caused depending on the degree of uniform coating and overall surface corrosion through the naked eye during the galvanizing coating process.

In addition, management agencies such as Korea Expressway Corporation had difficulties in accurately figuring out the need for replacement and reinforcement of the vehicle protection fence. After a problem occurred, a current state is identified through a visual inspection of workers and managers or civil complaints from civil servants and replacement work is carried out, making it difficult to accurately identify a place where work is needed.

In addition, necessary measures may be different depending on the difference in a surface corrosion level, but it is not easy to distinguish the difference only with the naked eye, and there is a limitation in that it is difficult to uniformly and evenly coat surfaces as devices capable of controlling work strength during operation are manually operated.

In addition, the degree of aging of the vehicle protection fence may vary depending on the surrounding environment and climate such as mountainous areas, dust volume, vehicle traffic, wetlands, and rainfall. In a situation in which what extent the aging has progressed is not known, the rusted areas are roughly predicted by considering an average lifespan of the vehicle protection fence (for example, 20 to 25 years in inland areas and 8 years in coastal areas) to identify where work is needed by conducting in-site survey.

On the other hand, artificial intelligence (AI) means that a machine learns and creates a black box that exists between input data and output data, which means that the machine creates a formula or a feature extractor that had been manually created by a human being in the past.

Since the formulas or weights in the black box are determined by the input data and the output data, it is important to process the input data and the output data according to the purpose of use.

In addition, the data pre-processing process is an essential process to be used for data analysis or artificial intelligence, which should be used according to a specific situation, and it is important to select an algorithm suitable for the purpose of use.

In particular, by using the machine learning model, images with various image conditions (e.g., lighting, background, and occlusion) may be processed effectively.

The machine learning algorithm may be, for example, a convolutional neural network, a support vector machine, a random forest or a neural network.

Optionally, the machine learning model is a model well suited for performing classification or regression on high-dimensional images (e.g., 10,000 pixels or more).

Among them, a convolutional neural network has made great strides toward automatic recognition and understanding of high-dimensional sensory data.

One of the fundamental ideas supporting these techniques is that algorithms determine how to best represent data by learning extraction of most useful features.

When the extracted features are good enough, any basic machine learning algorithm may be applied to the features to obtain good results.

The convolutional neural networks has a network model structure that maintains and learns spatial information of images, and creates a feature map using a filter around a specific area and performs learning such that a specific feature is present.

In particular, when the convolutional neural network is used in a computer vision field, the convolutional neural network may be used for classification, classification and localization, object detection, instance segmentation, or the like.

On the other hand, industrial datasets pose new challenges for deep learning which processes noisy or missing data, or inconsistent or partially labeled data.

In order for machine learning to perform good quality classification, it is needed to ensure good data quality for learning and train a sufficiently good model on the data.

Typically, users are required to prepare data for training by first examining the data and labeling the data until the users are satisfied with its quality.

The model is then trained on the cleaned data.

For example, in the case of detection of a painting work area of a vehicle protection fence, a learning network may be designed to enter object detection or segmentation, and use a convolutional neural network for object detection according to the labeling task difficulty and maintenance work characteristics.

By performing machine learning on the learning network designed as described above using input data and output data that have been labeled, a corrosion level is subdivided and accurately recognized, and high-quality painting work areas may be detected through overall consistent illuminance and color, without the manual method of checking the current status with unreliable visual inspection,

Therefore, the present inventors had invented a vehicle protection fence repair plating system and method using artificial intelligence, which detect only an area predicted to need repair work through vision artificial intelligence machine-learned based on data obtained by collecting conditions of a vehicle protection fence while driving a work vehicle and store the area in a database to reduce work time and establish a preset standard for work area detection.

### SUMMARY

Embodiments of the inventive concept provide a vehicle protection fence repair plating system using artificial intelligence capable of generating data on vehicle protection fence repair work requests and automatically determining a work area, analyzing an optimal work method for each area through a system for recognizing a process target and performing stepwise classification through vision artificial intelligence, to standardize work area determination.

Embodiments of the inventive concept provide a vehicle protection fence repair plating method using artificial intelligence, which prevent inefficiency of identifying the aging state of the vehicle protection fence in the site through site visits by a person, by using a vehicle protection fence aging prediction model.

Embodiments of the inventive concept provide a vehicle protection fence repair plating method using artificial intelligence to achieve the above objects.

According to an embodiment, a vehicle protection fence repair plating system includes a data management module that collects video data about a vehicle protection fence and pre-processes images per frame, a data prediction module that receives data of the pre-processed image and performs machine learning for a corrosion level of the vehicle protection fence according to a preset labeling standard to detect a work area; and a process management module that standardizes customized work instructions according to a determination result of an image state of the vehicle protection fence, which has been machine-learned, wherein the data prediction module specifies a repair range of the vehicle protection fence and a work method for each repair range according to the labeling standard.

The data management module may include a data collection unit which includes a vision camera and a GPS sensor and collects video data and location information for a vehicle protection fence in site, an environmental influence removal unit which receives the video data and removes influence of environmental factors in the site, a tool variable search unit which searches for a variable that does not affect the video data, and an autocorrelation removal unit that removes spatially continuous observations from the video data.

The data prediction module may include a deep learning modeling unit which receives the pre-processed image data and constructs a quality determination network, a model learning unit which detects the work area by performing machine learning for the corrosion level and a plating-required portion according to the preset labeling standard using the quality determination network, specifies the work method for each repair range, and updates learning network data, a quality determining unit which receives the updated learning network data and determines a state of an image linked with GPS using a feature map and a feature vector, and a determination result storage unit which stores the location information matching an input image of an image whose the image state is identified with respect to the detected work area.

The process management module may include a determination result receiving unit which receives the determination result from the determination result storage unit, a work standardization unit which standardizes the customized work instructions according to the determination result, an application condition suggesting unit which checks the work instructions, applies necessary parts and delete unnecessary parts, and a work method monitoring unit which monitors the work method for each repair range specified for each work target area.

According to an embodiment, a vehicle protection fence repair plating method includes (a) collecting, by a data management module, video data about a vehicle protection fence and pre-process images per frame, (b) receiving, by a data prediction module, data of the pre-processed image and performing machine learning for a corrosion level of the vehicle protection fence according to a preset labeling standard to detect a work area, and (c) standardizing, by a process management module, customized work instructions according to a determination result of an image state of the vehicle protection fence, which has been machine-learned, wherein a repair range of the vehicle protection fence and a work method for each repair range are specified according to the labeling standard.

The step (a) may include (a-1) collecting, by a data collection unit, video data and location information for a vehicle protection fence in site, the data collection unit including a vision camera and a GPS sensor, (a-2) receiving, by a server, the video data and the location information from the data collection unit through a wireless communication network and extracting an image per frame, and (a-3) receiving and pre-processing, by the server, the extracted image per frame, and outputting image data.

The step (b) may include (b-1) receiving, by a deep learning modeling unit, the pre-processed image data and constructing a quality determination network, (b-2) detecting, by a model learning unit, the work area by performing machine learning for the corrosion level and a plating-required portion according to the preset labeling standard using the quality determination network, specifying the work method for each repair range, and updating learning network data, (b-3) receiving, by a quality determining unit, the updated learning network data and determining a state of an image linked with GPS using a feature map and a feature vector, and (b-4) storing, by a determination result storage unit, the location information matching an input image of an image whose the image state is identified with respect to the detected work area.

In the step (b-2), the preset labeling standard may be classified into an initial surface maintenance state (\textcircled{1}), a gloss loss and bolt part whitening state (\textcircled{2}), a blackening state (\textcircled{3}), a yellowing state (\textcircled{4}), yellowing accelerated and white rust state (\textcircled{5}), a surface red rust state (\textcircled{6}), and an overall red rust state (\textcircled{7}).

The work method for each repair range may be set to perform high-pressure washing and drying processes and perform plating using a hot-dip galvanizing plating using eco-friendly metal paints in the state (\textcircled{2}) to the state (\textcircled{4}), and may be set to remove rust with a rust remover, perform a drying process, and then perform plating using the hot-dip galvanizing method in the above state (\textcircled{5}).

The step (c) may include (c-1) receiving, by a determination result receiving unit, the determination result from the determination result storage unit, (c-2) standardizing, by a work standardization unit, the customized work instruction according to the determination result, (c-3) checking, by an application condition suggesting unit, work instructions, applying a necessary part and deleting an unnecessary part; and (c-4) monitoring, by a work method monitoring unit, a work method for each repair range specified for each work target area.

Other specific details of the inventive concept are included in the detailed description and drawings

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic configuration diagram for describing overall operation of a vehicle protection fence repair plating system using artificial intelligence according to an embodiment of the inventive concept;

FIG. 2 is a block diagram of a vehicle protection fence repair plating system using artificial intelligence according to an embodiment of the inventive concept;

FIG. 3 is a flowchart for describing an overall operation of the vehicle protection fence repair plating method using artificial intelligence according to an embodiment of the inventive concept;

FIG. 4 is a flowchart for describing a detailed operation of step S100 of the vehicle protection fence repair plating method shown in FIG. 3;

FIG. 5 is a flowchart for describing a detailed operation of step S200 of the vehicle protection fence repair plating method shown in FIG. 3;

FIG. 6 is a flowchart for describing a detailed operation of step S300 of the vehicle protection fence repair plating method shown in FIG. 3;

FIG. 7 is an exemplary photograph of a vehicle protection fence classified according to a corrosion level in step S220 of the vehicle protection fence repair plating method shown in FIG. 5;

FIG. 8 is a photograph showing preset seven corrosion levels and specified repair ranges of the vehicle protection fence according to labeling standards in step S220 of the vehicle protection fence repair plating method shown in FIG. 5;

FIGS. 9A to 9C are tables for the period and state of use of the vehicle protection fence classified according to the seven corrosion levels shown in FIG. 8, which are tables in which cases in which the vehicle protection fence is installed in a marine environment and a general environment are classified; and

FIG. 10 is a schematic configuration diagram for describing an operation in which a model learning unit performs machine learning to detect a work area in step S220 of the vehicle protection fence repair plating method shown in FIG. 5.

### DETAILED DESCRIPTION

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated elements, but do not preclude the presence or addition of elements. Like reference numerals refer to like elements throughout the specification, and “and/or” includes each and all combinations of one or more of the mentioned elements. Although “first”, “second”, and the like are used to describe various components, these components are of course not limited by these terms. These terms are only used to distinguish one component from another. Thus, a first element discussed below could be termed a second element without departing from the teachings of the inventive concept

Unless otherwise defined, all terms (including technical and scientific terms) used herein have the same meaning as commonly understood by one of ordinary skill in the art to which this invention belongs. It will be further understood that terms such as those defined in commonly used dictionaries, will not be interpreted in an idealized or overly formal sense unless expressly so defined herein.

Hereinafter, embodiments of the present disclosure will be described with reference to the accompanying drawings.

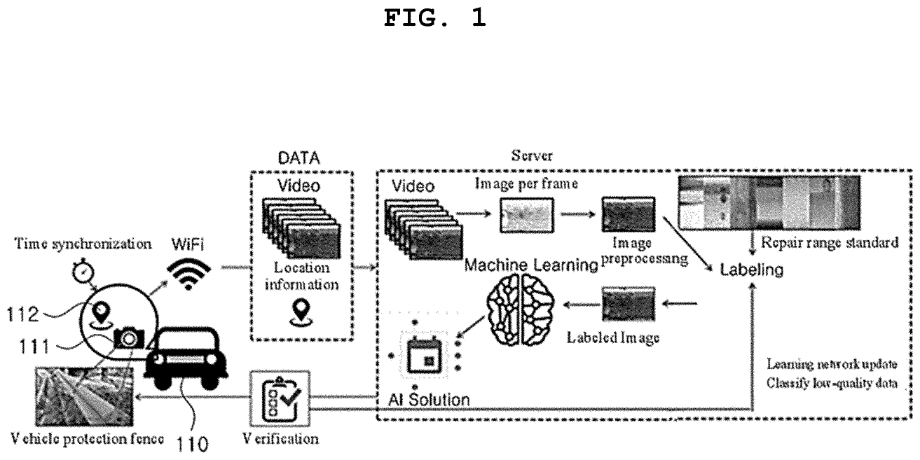

FIG. 1 is a schematic configuration diagram for describing overall operation of a vehicle protection fence repair plating system using artificial intelligence according to an embodiment of the inventive concept.

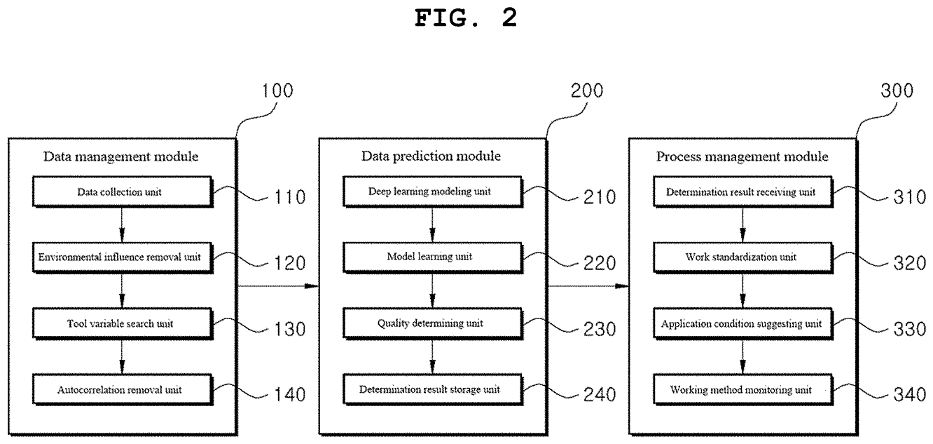

FIG. 2 is a block diagram of a vehicle protection fence repair plating system using artificial intelligence according to an embodiment of the inventive concept, and the vehicle protection fence repair plating system includes a data management module 100, a data prediction module 200, and a process management module 300.

The data management module 100 may include a data collection unit 110, an environmental influence removal unit 120, a tool variable search unit 130, and an autocorrelation removal unit 140.

The data prediction module 200 may include a deep learning modeling unit 210, a model learning unit 220, a quality determining unit 230, and a determination result storage unit 240.

The process management module 300 may include a determination result receiving unit 310, a work standardization unit 320, an application condition suggesting unit 330, and a working method monitoring unit 340.

The overall operation and component functions of the vehicle protection fence repair plating system using artificial intelligence according to an embodiment of the inventive concept will be schematically described with reference to FIGS. 1 and 2.

The data management module 100 may collect video data about vehicle protection fences, and pre-process per-frame images.

That is, the data collection unit 110 may be equipped with a vision camera 111 and a GPS sensor 112 to collect video data and location information about a vehicle protection fence on the site. The environmental influence removal unit 120 may receive the video data from the data collection unit 110 and remove the influence of environmental factors on the site.

In addition, the tool variable search unit 130 may search for variables that do not affect the video data, and the autocorrelation removal unit 140 may remove spatially continuous observations from the video data.

The data prediction module 200 may receive the data of images pre-processed by the data management module 100 and perform machine learning according to a labeling standard previously set for a corrosion level of the vehicle protection fence to detect a work area.

In this case, the data prediction module 200 may specify a repair range of the vehicle protection fence and a work method for each repair range according to the predetermined labeling standard.

That is, the deep learning modeling unit 210 may receive the image data pre-processed in the data management module 100 and build a quality determination network.

After the model learning unit 220 may detect a work area by performing machine learning according to preset labeling standards for a corrosion level and a plating-required portion using a quality determination network, specify a work method for each repair range, and update the learning network data.

In addition, the quality determining unit 230 may receive the learning network data updated by the model learning unit 220, and determine the state of the image linked to the GPS using the feature map and the feature vector, and the determination result storage unit 240 may store position information matched with a corresponding input image of the image whose image state is determined by the quality determining unit 230, with respect to the work area detected by the model learning unit 220.

The process management module 300 may standardize the customized work instruction according to the determination result for the state of the image of the vehicle protection fence machine-learned by the data prediction module 200.

That is, the determination result receiving unit 310 may receive the determination result from the determination result storage unit 240, and the work standardization unit 320 may standardize the customized work instruction according to the determination result.

In addition, the application condition suggesting unit 330 may check the work instruction sheet, apply a necessary part and delete an unnecessary part, and the working method monitoring unit 340 may monitor a work method for each repair range specified for each work target region.

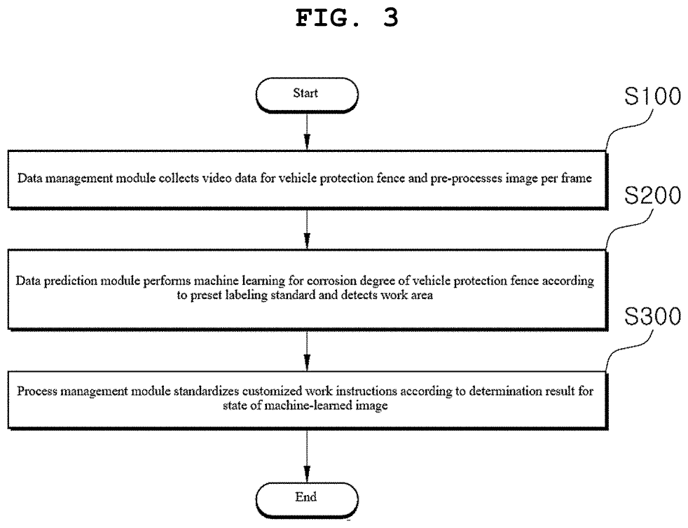

FIG. 3 is a flowchart for describing an overall operation of the vehicle protection fence repair plating method using artificial intelligence according to an embodiment of the inventive concept.

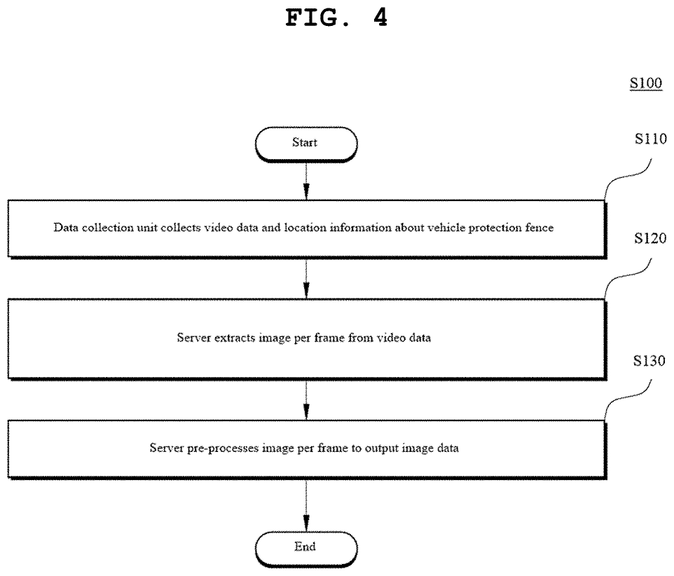

FIG. 4 is a flowchart for describing a detailed operation of step S100 of the vehicle protection fence repair plating method shown in FIG. 3.

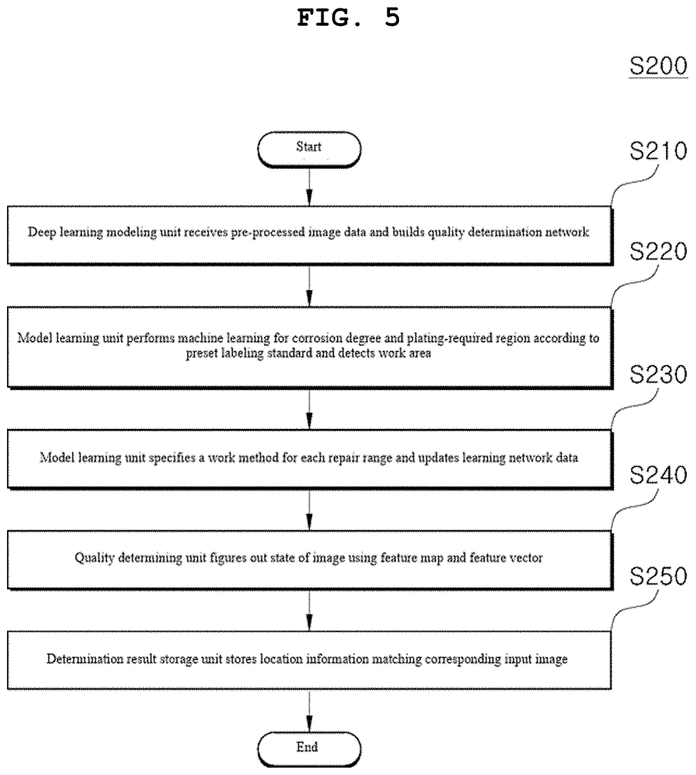

FIG. 5 is a flowchart for describing a detailed operation of step S200 of the vehicle protection fence repair plating method shown in FIG. 3.

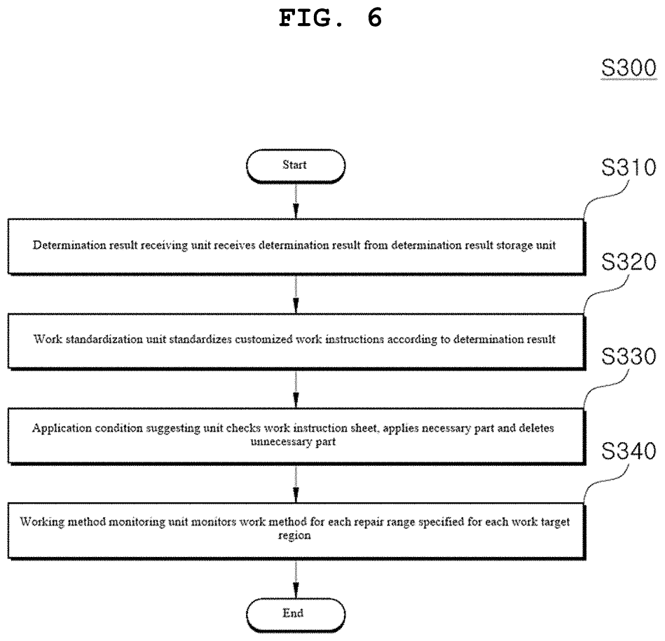

FIG. 6 is a flowchart for describing a detailed operation of step S300 of the vehicle protection fence repair plating method shown in FIG. 3.

Operations of the vehicle protection fence repair plating method using artificial intelligence according to an embodiment of the inventive concept will be schematically described with reference to FIGS. 1 to 6.

First, the data management module 100 may collect video data for a vehicle protection fence, and pre-process an image per frame (S100).

That is, the data collection unit 110 may include the vision camera 111 and the GPS sensor 112 and may collect video data and location information about a vehicle protection fence on the site (S110), and a server may receive video data and location information from the data collection unit 110 through a wireless communication network, extract an image per frame (S120), and pre-process the image to output image data (S130).

Next, the data prediction module 200 may receive the data of images pre-processed by the data management module 100, perform machine learning for a corrosion level of the vehicle protection fence according to a preset labeling standard and detect a work area (S200).

That is, when the deep learning modeling unit 210 receives the pre-processed image data from the data management module 100 and builds a quality determination network (S210), the model learning unit 220 may perform machine learning according to preset labeling standards for a corrosion level and a plating-required portion using the quality determination network.

Through this, after detecting the work area and specifying the work method for each repair range, the learning network data is updated (S220), and the quality determining unit 230 may receive the updated learning network data from the model learning unit 220, and figure out the state of an image linked with GPS using a feature map and a feature vector (S230).

In addition, the quality determining unit 230 may receive the updated learning network data from the model learning unit 220, and figure out the state of an image linked with GPS using a feature map and a feature vector (S240).

Next, the process management module 300 may standardize the customized work instruction according to the determination result for the state of the image of the vehicle protection fence machine-learned by the data prediction module 200 (S300).

That is, the determination result receiving unit 310 may receive the determination result from the determination result storage unit 240 in the data prediction module 200 (S310) and the work standardization unit 320 may standardize the customized work instruction according to the determination result (S320).

In addition, the application condition suggesting unit 330 may check the work instruction sheet, apply a necessary part and delete an unnecessary part (S330) and the working method monitoring unit 340 may monitor a work method for each repair range specified for each work target region (S340).

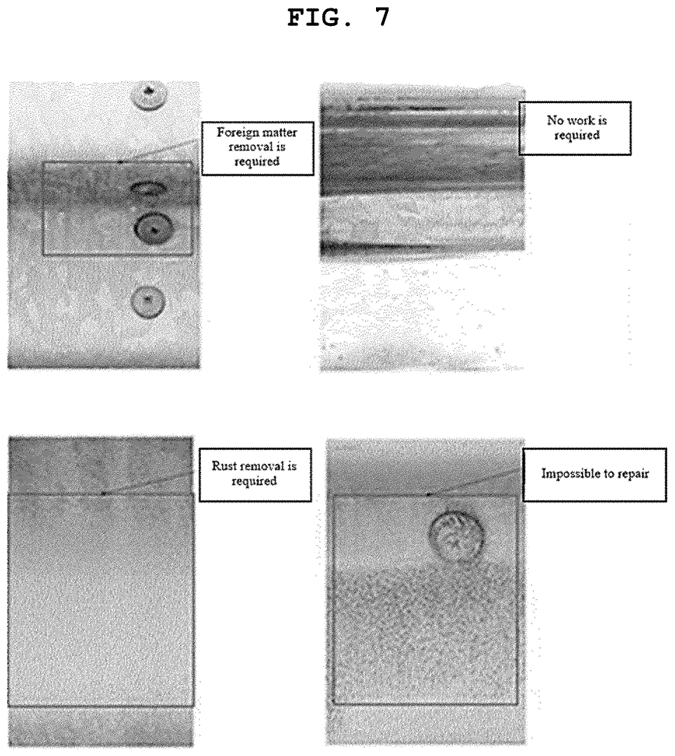

FIG. 7 is an exemplary photograph of a vehicle protection fence classified according to a corrosion level in step S220 of the vehicle protection fence repair plating method shown in FIG. 5.

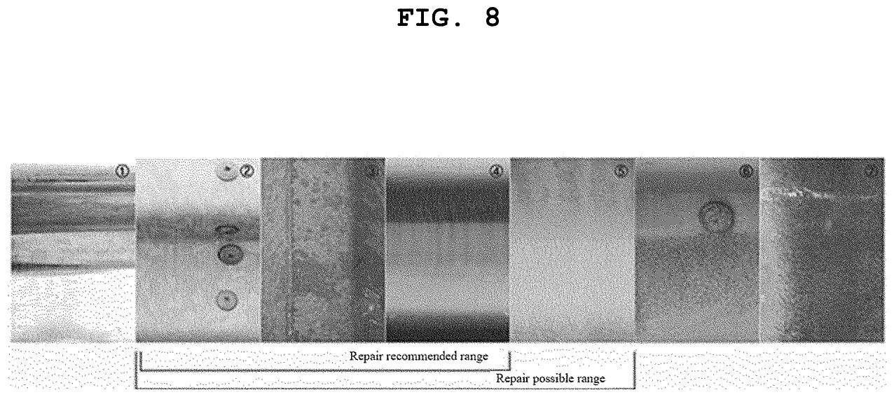

FIG. 8 is a photograph showing preset seven corrosion levels and specified repair ranges of the vehicle protection fence according to labeling standards in step S220 of the vehicle protection fence repair plating method shown in FIG. 5.

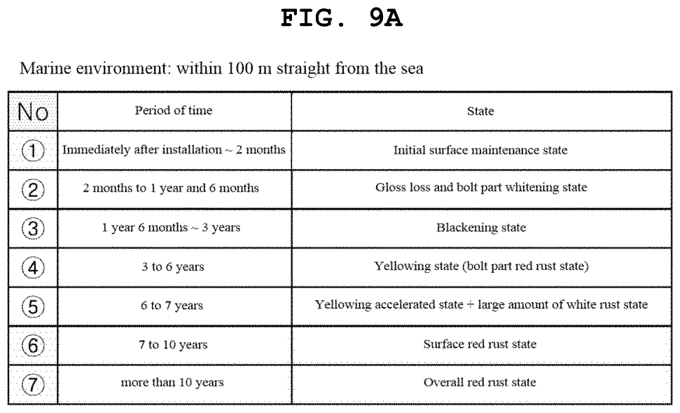

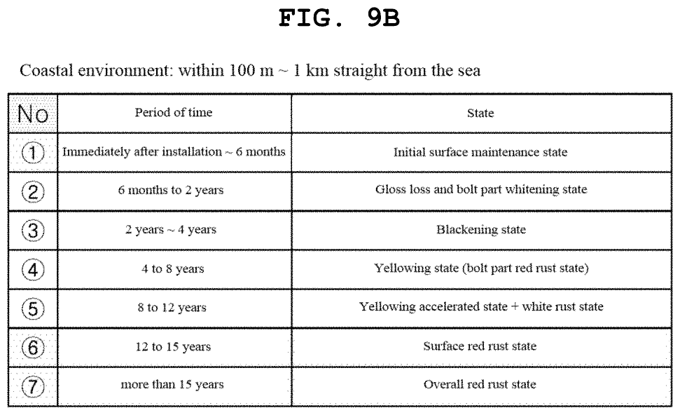

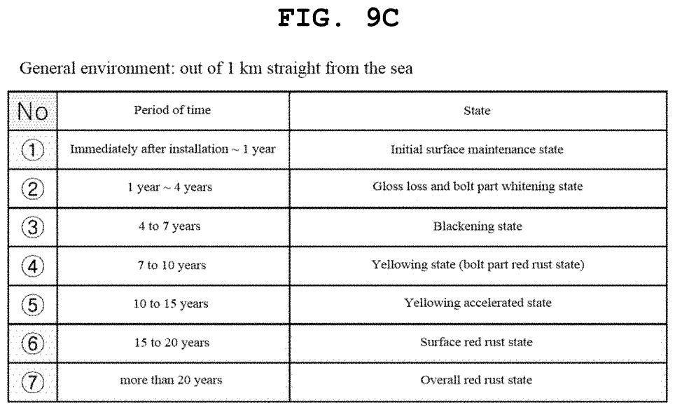

FIGS. 9A to 9C are tables for the period and state of use of the vehicle protection fence classified according to the seven corrosion levels of shown in FIG. 8, which are tables in which cases in which the vehicle protection fence is installed in a marine environment and a general environment are classified.

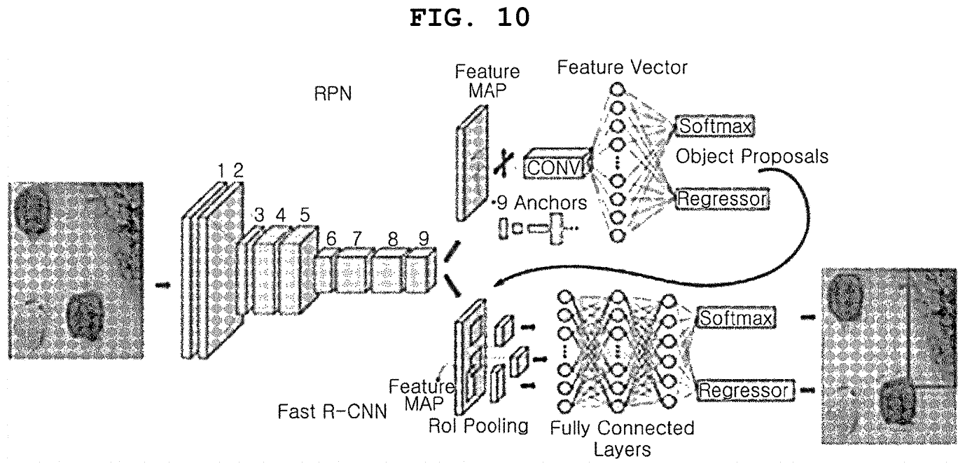

FIG. 10 is a schematic configuration diagram for describing an operation in which the model learning unit 220 performs machine learning to detect a work area in step S220 of the vehicle protection fence repair plating method shown in FIG. 5.

Operations of the vehicle protection fence repair plating method using artificial intelligence according to an embodiment of the inventive concept will be schematically described with reference to FIGS. 1 to 10.

First, an operation of the data management module 100 will be described in detail as follows.

The vehicle, which is the data collection unit 110, may collect video data about a vehicle protection fence in the site through the vision camera 111 and the GPS sensor 112.

That is, as shown in FIG. 1, a vehicle protection fence in the site is captured by a work vehicle in the site or a general vehicle equipped with separately manufactured light shielding equipment, the vehicle including the vision camera 111 and the GPS sensor 112 which are time-synchronized with each other.

In this case, the vision camera 111 may include a vision sensor and an RGB sensor.

In addition, when photographing with the work vehicle, the amount of image pre-processing is low and data quality is high, and the amount of data collection is small, whereas when photographing with a general vehicle, a large amount of data is able to be collected within a short time.

The video data captured by the work vehicle or the general vehicle may be transmitted together with the location information sensed by the GPS sensor 112 to the server.

The server may receive video data and location information from a vehicle through a wireless communication network and extract images per frame.

In the image pre-processing step, the environmental influence removal unit 120 may receive video data from the data collection unit 110 and remove the influence of environmental factors such as light and dust in the site, and the tool variable search unit 130 may search for a variable that does not affect the video data. The autocorrelation removal unit 140 may remove spatially continuous observation values in the video data.

That is, to block the most influential light in collecting vehicle protection fence image data, according to the inventive concept, a uniform DB may be generated by first blocking light using an RGB-HSV conversion formula in the image pre-processing step.

Here, since the RGB-HSV conversion formula is a well-known technique in the art, a detailed description will be omitted in this embodiment.

The environmental influence removal unit 120 may convert RGB images into HSV images to suppress the influence of illuminance on the collected data and to generate uniform data.

The reason for this is that, when using normal RGB, image data is greatly affected by environmental factors such as shadows and lighting, but when using HSV, the influence of shadows or lighting is reduced.

Next, the operation of the data prediction module 200 will be described in detail as follows.

In the labeling step, the deep learning modeling unit 210 may receive the image data pre-processed in the image pre-processing step to build a CNN, which is a quality determination network, and the model learning unit 220 may update learning network data after machine learning has been performed to detect the work area using a CNN.

That is, the labeling step may create a machine learning DB by labeling the image in which the pre-processing has been subjected to the image pre-processing step, with the corrosion level and the plating-required portion according to preset labeling standards.

In this case, as shown in FIG. 7, the corrosion level may be classified into a state (a) in which foreign matter removal is required, a state (b) in which plating operation is not required, a state (c) in which rust removal is required, and a state (d) in which rust removal is required but repair is not possible.

In addition, as shown in FIGS. 8 and 9A to 9C, according to a coastal environment and a general environment, the labeling standards may be classified into an initial surface maintenance state (\textcircled{1}), a gloss loss and bolt part whitening state (\textcircled{2}), a blackening state (\textcircled{3}), a yellowing state (\textcircled{4}), yellowing accelerated (and white rust) state (\textcircled{5}), a surface red rust state (\textcircled{6}), and an overall red rust state (\textcircled{7}).

A portion required for plating may be set by specifying a repair range such that, among the conditions, the corrosion levels of state (\textcircled{2}) to state (\textcircled{5}) are within a repair possible range by galvanizing, and the corrosion levels of condition (\textcircled{2}) to condition (\textcircled{4}) are within a repair recommended range by galvanizing.

The work method for each repair range is as follows.

The states (\textcircled{2}) to (\textcircled{4}) are states in which red rust has not yet progressed, and after high-pressure washing and drying processes have been performed, plating is performed using an automatic coating repair method for vehicle protection fences using eco-friendly metal paints according to a hot-dip galvanizing method.

The state (\textcircled{5}) is a state in which red rust has progressed by about 3 to 15%, and after removing rust for about 10 minutes with a rust remover and performing drying process, plating is performed using the hot-dip galvanizing method.

The state (\textcircled{6}) is a state in which red rust has progressed by about 16-50%, and after coating is performed with a gel-type rust remover, a liquid-type rust remover is sprayed and dried, and then plating is performed using the hot-dip galvanizing method.

The state (\textcircled{7}) is a state in which red rust has spread all over, and further repair is impossible and the vehicle protection fence needs to be replaced.

This repair range standards are the basis of the labeling operation, and as shown in FIG. 1, the labeling step may include performing labeling according to the standard of the work target, and machine-learning the labeled image to recognize and classify the work target.

The quality determining unit 230 in the data prediction module 200 may receive the updated learning network data from the model learning unit 220, filter out low-quality data, and store the quality determination result in the big database, which is the determination result storage unit 240.

That is, as shown in FIG. 10, the quality determining unit 230 may receive an input image using the learned convolutional neural network and determine the state of an image linked with GPS using a feature map and a feature vector.

In addition, the determination result storage unit 240 may store data regarding the detected work area, which is a result of outputting an image whose image state is determined by the quality determining unit 230, together with coordinate information or location information matching a corresponding input image in a big database and perform visual notification to a work manager through a predetermined display.

The work manager may directly visit the site, check an actual state, and compare and verify the actual state with an image transmitted to the display. When the prediction accuracy of the data prediction module 200 is not high, the work manager may continuously correct and supplement learning data to update the learning network.

Through this, it is possible to continuously improve the accuracy of the learning model by verifying the accuracy by comparing and verifying the output of a learned model with a work vehicle participating in the actual process work, and continuously correcting defective data.

Next, the operation of the process management module 300 will be described in detail as follows.

The determination result receiving unit 310 may receive the determination result from the determination result storage unit 240 in the data prediction module 200, and the work standardization unit 320 may standardize the customized work instruction according to the determination result.

In addition, the application condition suggesting unit 330 may perform overall management such as checking the work instruction sheet, applying a necessary part and deleting an unnecessary part, and the working method monitoring unit 340 may monitor a work method for each repair range for each work target region.

Through this, needs of demanding companies may be automatically linked with a work instruction sheet by standardizing the maintenance work of the vehicle protection fence, and thus anyone may present the same result through a method with consistent standards for provision of work to be performed by the worker according to the degree of aging of a detected area.

In addition, it is possible to secure economic feasibility through repair work by providing a stepwise work method based on certain standards, instead of a conventional method in which portions determined to be problematic by visual inspection are replaced, and achieve efficient schedule management such as maintenance or replacement cycle through time factors.

As described above, the inventive concept may provide a vehicle protection fence repair plating system and method using artificial intelligence capable of generating data on vehicle protection fence repair work requests and automatically determining a work area, analyzing an optimal work method for each area through a system for recognizing a process target and performing stepwise classification through vision artificial intelligence, to standardize work area determination.

In addition, the inventive concept may provide a vehicle protection fence repair plating system and method using artificial intelligence, which prevent inefficiency of identifying the aging state of the vehicle protection fence in the site through site visits by a person, by using a vehicle protection fence aging prediction model.

Through this, according to the inventive concept, it is possible to secure grounded data of a work proposal to be requested from a related institution within a short period of time by predicting and detecting aging of the vehicle protection fence in advance.

In addition, it is possible to use big data in not only vehicle protection fences, but also similar types of structures, such as hot-dip galvanized steel structure, plant piping, mechanical equipment by improving the accuracy of a detection system through continuous data aggregation and continuously building basic materials of a prediction model as big data,

The steps of a method or algorithm described in connection with the embodiments of the present disclosure may be implemented directly in hardware, in a software module executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or in a computer readable recording medium that is well known in the art.

Although embodiments of the present disclosure have been described above with reference to the accompanying drawings, it is understood that those skilled in the art to which the present disclosure pertains may implement the present disclosure in other specific forms without changing the technical spirit or essential features thereof. Therefore, it should be understood that the embodiments described above are illustrative in all respects and not restrictive.

According to the inventive concept, it is possible to secure the basis of the work proposal requested to the relevant agency within a short period of time by predicting and detecting the deterioration of the vehicle protection fence in advance.

In addition, by improving the accuracy of the detection system through continuous data aggregation and continuously building the basic data of the predictive model as big data, the big data may be used not only for vehicle protection fences, but also for similar types of structures such as hot-dip galvanized steel structures, plant piping, and mechanical equipment.

However, effects of the inventive concept are may not be limited to the above-described effects. Although not described herein, other effects of the inventive concept can be clearly understood by those skilled in the art from the following description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A vehicle protection fence repair plating system comprising: a data management module configured to collect video data about a vehicle protection fence and pre-process images per frame;
a data prediction module configured to receive data of the pre-processed image and perform machine learning for a corrosion level of the vehicle protection fence according to a preset labeling standard to detect a work area; and
a process management module configured to standardize customized work instructions according to a determination result of an image state of the vehicle protection fence, which has been machine-learned,
wherein the data prediction module is configured to specify a repair range of the vehicle protection fence and a work method for each repair range according to the labeling standard.

2. The vehicle protection fence repair plating system of claim 1, wherein the data management module includes
a data collection unit having a vision camera and a GPS sensor and configured to collect video data and location information for a vehicle protection fence in site;
an environmental influence removal unit configured to receive the video data and remove influence of environmental factors in the site;
a tool variable search unit configured to search for a variable that does not affect the video data; and
an autocorrelation removal unit configured to remove spatially continuous observations from the video data.

3. The vehicle protection fence repair plating system of claim 2, wherein the data prediction module includes
a deep learning modeling unit configured to receive the pre-processed image data and construct a quality determination network;
a model learning unit configured to detect the work area by performing machine learning for the corrosion level and a plating-required portion according to the preset labeling standard using the quality determination network, specify the work method for each repair range, and update learning network data;
a quality determining unit configured to receive the updated learning network data and determine a state of an image linked with GPS using a feature map and a feature vector; and
a determination result storage unit configured to store the location information matching an input image of an image whose the image state is identified with respect to the detected work area.

4. The vehicle protection fence repair plating system of claim 3, wherein the process management module includes
a determination result receiving unit configured to receive the determination result from the determination result storage unit;
a work standardization unit configured to standardize the customized work instructions according to the determination result;
an application condition suggesting unit configured to check the work instructions, apply necessary parts and delete unnecessary parts; and
a work method monitoring unit configured to monitor the work method for each repair range specified for each work target area.

5. A vehicle protection fence repair plating method comprising:
(a) collecting, by a data management module, video data about a vehicle protection fence and pre-process images per frame;
(b) receiving, by a data prediction module, data of the pre-processed image and performing machine learning for a corrosion level of the vehicle protection fence according to a preset labeling standard to detect a work area; and
(c) standardizing, by a process management module, customized work instructions according to a determination result of an image state of the vehicle protection fence, which has been machine-learned,
wherein a repair range of the vehicle protection fence and a work method for each repair range are specified according to the labeling standard.

6. The vehicle protection fence repair plating method of claim 5, wherein the step (a) includes
(a-1) collecting, by a data collection unit, video data and location information for a vehicle protection fence in site, the data collection unit including a vision camera and a GPS sensor;
(a-2) receiving, by a server, the video data and the location information from the data collection unit through a wireless communication network and extracting an image per frame;
(a-3) receiving and pre-processing, by the server, the extracted image per frame, and outputting image data.

7. The vehicle protection fence repair plating method of claim 6, wherein the step (b) includes
(b-1) receiving, by a deep learning modeling unit, the pre-processed image data and constructing a quality determination network;
(b-2) detecting, by a model learning unit, the work area by performing machine learning for the corrosion level and a plating-required portion according to the preset labeling standard using the quality determination network, specifying the work method for each repair range, and updating learning network data;
(b-3) receiving, by a quality determining unit, the updated learning network data and determining a state of an image linked with GPS using a feature map and a feature vector; and
(b-4) storing, by a determination result storage unit, the location information matching an input image of an image whose the image state is identified with respect to the detected work area.

8. The vehicle protection fence repair plating method of claim 7, wherein, in the step (b-2), the preset labeling standard is classified into an initial surface maintenance state (\textcircled{1}), a gloss loss and bolt part whitening state (\textcircled{2}), a blackening state (\textcircled{3}), a yellowing state (\textcircled{4}), yellowing accelerated and white rust state (\textcircled{5}), a surface red rust state (\textcircled{6}), and an overall red rust state (\textcircled{7}).

9. The vehicle protection fence repair plating method of claim 8, wherein the work method for each repair range is set to perform high-pressure washing and drying processes and perform plating using a hot-dip galvanizing plating using eco-friendly metal paints in the state (\textcircled{2}) to the state (\textcircled{4}), and is set to remove rust with a rust remover, perform a drying process, and then perform plating using the hot-dip galvanizing method in the above state (\textcircled{5}).

10. The vehicle protection fence repair plating method of claim 7, wherein the step (c) includes
(c-1) receiving, by a determination result receiving unit, the determination result from the determination result storage unit;
(c-2) standardizing, by a work standardization unit, the customized work instruction according to the determination result;
(c-3) checking, by an application condition suggesting unit, work instructions, applying a necessary part and deleting an unnecessary part; and
(c-4) monitoring, by a work method monitoring unit, a work method for each repair range specified for each work target area.
